(19) United States
(12) Patent Application Publication
(10) Pub. No.: US 2016/0305264 A1
(43) Pub. Date: Oct. 20, 2016

(54) TURBOMACHINE ROTOR-STATOR SEAL

(71) Applicant: UNITED TECHNOLOGIES CORPORATION, Hartford, CT (US)

(72) Inventors: Jordan T. Wall, Hartford, CT (US); William W. Frank, Cheshire, CT (US); Davis S. Jang, Sammamish, WA (US)

(21) Appl. No.: 15/101,208

(22) PCT Filed: Nov. 19, 2014
(86) PCT No.: PCT/US2014/066274

§ 371 Date: Jun. 2, 2016

Related U.S. Application Data
(60) Provisional application No. 61/912,303, filed on Dec. 5, 2013.

(51) Int. Cl. F01D 11/00; F01D 5/02; F01D 5/12; F01D 9/04

(52) U.S. Cl. CPC F01D 11/001; F01D 9/041; F01D 5/02; F01D 5/12; F05D 2220/32; F05D 2240/80

(57) ABSTRACT

A seal component for a turbomachine includes a stator platform configured to be disposed on an end of a stator airfoil and a scoop disposed on a first edge of the stator platform configured to be oriented obliquely with respect the stator airfoil and configured for generating a region of high pressure static fluid flow adjacent the first edge of the stator platform.

### RELATED APPLICATIONS

This application claims the benefit of and priority to U.S. Provisional Patent Application No. 61/912,303 filed Dec. 5, 2013, the contents of which are incorporated herein by reference in their entirety.

### BACKGROUND

1. Field

The present disclosure relates to gas turbine engines, and more particularly to rotating gas turbine components requiring seals between stages of varying pressures.

2. Description of Related Art

Labyrinth seals are the current preferred method for sealing shrouded stator cavities (rim cavities). These seals have been used in many commercial and military compressor and turbine applications to date. These seals are very robust with good sealing capability. However there is a need for a large cavity volume in order to package the stator damper, the honeycomb, and have room for the knives. This results in a large amount of heat generation due to larger surface areas being exposed to the working fluid. More specifically, heat is generated as the drag by the static surface converts some of the work done by the rotating surface into heat. Large cavity volumes lead to greater heat generation due to the increase in work done on the fluid by more rotating surface, and increase in drag due to more static surface. This heat generation results in temperatures that can be a limiting factor on rotor lives, e.g., on the back end of compressors and in turbines.

To enable better thermal efficiency, component efficiency and overall pressure ratio must increase. One method to increase compressor efficiency is to reduce leakage flow through the seals in the compressor. However a reduction in leakage flow, without a corresponding reduction in heat generation could result in increased rotor temperatures and decreased rotor life. Also, many seals require brushes or other wearable contact to properly seal each stage of a turbomachine from the last. The wearable seals and other components that contact them must be replaced after sufficient use.

Such conventional methods and systems have generally been considered satisfactory for their intended purpose. However, there is still a need in the art for a seal that decreases leakage flow without increasing heat generation. Also, efficient contactless seals are also needed. The present disclosure provides solutions for these problems.

### SUMMARY

A seal component for a turbomachine includes a stator platform configured to be disposed on an end of a stator airfoil, and a scoop disposed on a leading edge of the stator platform configured to be oriented obliquely with respect the stator airfoil and configured for generating a region of high pressure static fluid flow adjacent the leading edge of the stator platform.

An end of the scoop can be axially or radially offset forward or aft from the stator airfoil. In some embodiments, a surface of the scoop can define an airfoil. The scoop can be a forward scoop and the stator platform can further include an flow discourager defined on an aft edge of the stator platform opposite the forward scoop. In this embodiment, an end of the flow discourager can be axially offset from the aft edge the stator airfoil.

In some embodiments, a surface of at least one of the forward scoop and flow discourager can define an airfoil. A flow guide can extend from a surface of the stator platform opposite the stator airfoil. A first end of the flow guide can extend obliquely with respect to the stator platform. The flow guide can be a first flow guide and the stator platform can further include a second flow guide extending from the surface of the stator platform opposite the stator airfoil. The second flow guide can extend obliquely with respect to the stator platform

In at least one aspect of this disclosure, a turbomachine can include at least one stator having a sealing component as disclosed above. The turbomachine can further include a rotor having a rotor blade and a rotor lip, the rotor lip including a curved surface. A top surface of the scoop can be flush with a top surface of the rotor lip.

In another aspect of this disclosure, a method includes the step of compressing a compressible fluid using a first rotor disposed on a rotor assembly and a first stator disposed on a turbomachine casing, the compressible fluid being compressed from a first pressure before the first stator to a second pressure after the first stator, thereby creating a differential pressure between a forward side and an aft side of the stator by recovering some static pressure from the total pressure of the fluid. The method also includes the step of directing a directed portion of the compressible fluid on the forward side of the first stator toward a gap between the rotor assembly and the first stator, and increasing static pressure on the forward side of the stator proximate the gap using the directed portion of the compressible fluid, thereby reducing the differential pressure between the forward side and the aft side of the stator, which acts to at least partially seal compressed fluid from flowing through the gap from the aft side of the stator to the forward side of the stator.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a partial, cross-sectional side elevation view of an embodiment of a turbomachine compressor section constructed in accordance with the present disclosure, showing a rotor-stator seal;

FIG. 2 is a partial, cross-sectional side elevation view of an embodiment of a turbomachine compressor section constructed in accordance with the present disclosure, showing another embodiment of rotor-stator seal;

FIG. 3 is a partial, cross-sectional side elevation view of an embodiment of a turbomachine compressor section constructed in accordance with the present disclosure, showing another embodiment of rotor-stator seal;

FIG. 4 is a partial, cross-sectional side elevation view of an embodiment of a turbomachine compressor section constructed in accordance with the present disclosure, showing another embodiment of rotor-stator seal; and

FIG. 5 is a partial, cross-sectional side elevation view of an embodiment of a turbomachine compressor section constructed in accordance with the present disclosure, showing another embodiment of rotor-stator seal.

### DETAILED DESCRIPTION

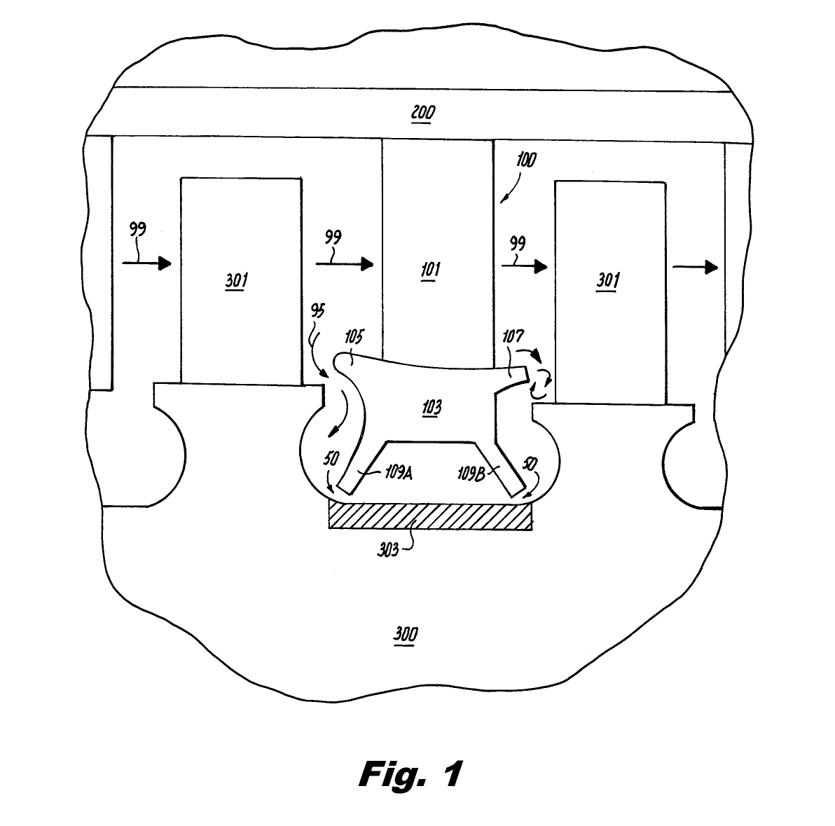

Reference will now be made to the drawings wherein like reference numerals identify similar structural features or aspects of the subject disclosure. For purposes of explanation and illustration, and not limitation, a partial view of an embodiment of rotor-stator assembly in accordance with the disclosure is shown in FIG. 1. The embodiments described herein refer to gas turbomachines, but it will be readily understood by one having ordinary skill in the art that the systems and methods described herein can be used for any terrestrial, marine, and/or aircraft gas turbomachines, or any other suitable rotor-stator combination. The structures and techniques disclosed herein can improve sealing between static and rotary turbomachine components using dynamic pressure to reduce or prevent pressure gradients that would otherwise drive leaking through the seal.

In at least one embodiment, a stator 100 includes a stator airfoil 101. The stator airfoil 101 can include any suitable airfoil shape and can be configured for use in any desired turbomachine, including, but not limited to, turbofan engines.

A stator platform 103 is disposed on an end of the stator airfoil 101, which is radially inward from a base of the stator 100. The stator platform 103 may be integrally formed from the stator 100 or be attached via any suitable attachment (e.g. adhesives, welding, etc.). The stator platform 103 can be annular (continuous or suitably segmented), whereas separate stator airfoils 101 can be circumferentially spaced along the stator platform 103. In some embodiments, the stator platform 103 can be disposed in any other suitable manner adjacent rotor assembly 300.

The stator platform 103 is configured to at least partially seal the forward side of stator 100 from the aft side of stator 100 (which generally has higher pressure than the forward side).

A forward scoop 105 is disposed on an upstream/forward edge of the stator platform 103 and can be oriented obliquely with respect the stator airfoil 101. The forward scoop 105 can be integral with the stator platform 103 or attached thereto in any other suitable manner. The forward scoop 105 is configured for generating a region of high pressure static fluid flow adjacent the forward edge of the stator platform 103. Scoop 105 can be annularly disposed (e.g. continuously or suitably segmented).

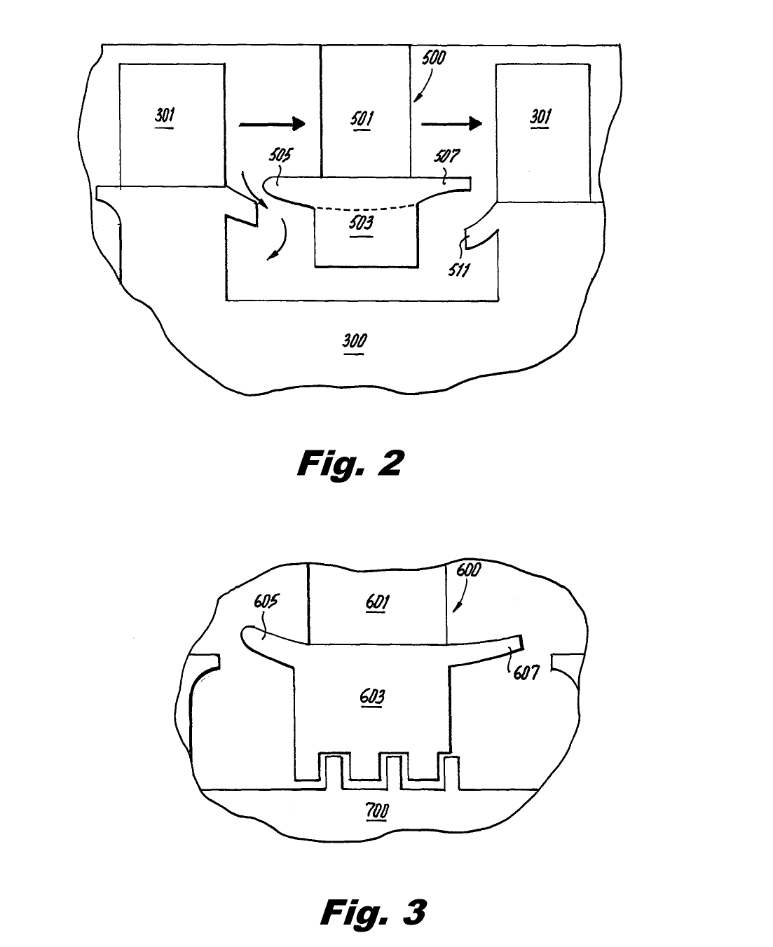

An end of the forward scoop 105 can be axially, circumferentially, and/or radially offset from the stator airfoil 103 such that the forward scoop 105 can protrude at least partially up and into the main flow path 99 of the rotor-stator assembly. In some embodiments, a fluid contacting surface of the forward scoop 105 can define any suitable airfoil shape oriented into the flow such that the airfoil shape enhances the reduction of dynamic pressure and an increase in local static pressure to reduce the differential pressure between forward and aft sides of the stator 100. In some embodiments, forward scoop 105 can include an airfoil design that is flat and/or flush with the stator platform 103 such that forward scoop 105 is no higher in radius than the stator platform 103 (see forward scoop 505 in FIG. 2). Also, the bottom side of the airfoil of forward scoop 105 can extend aft at an angle between about 0 degrees and about 35 degrees below horizontal, or any other suitable angle.

In some embodiments, the amount of axial and/or radial protrusion of the forward scoop 105 into the main flow path 99 can be from about 0% to about 5% of the radial span of the stator airfoil 101. It is contemplated that the protrusion of the forward scoop 105 can be higher than about 5% as suitable for specific applications. With greater protrusion comes a larger reduction in the differential pressure between the forward and aft sides of the stator 100.

The stator platform 103 can further include a flow discourager 107 defined on an aft edge of the stator platform 103 opposite the forward scoop 105. Similar to the forward scoop 105, an end of the flow discourager 107 can be axially and/or radially offset from the stator airfoil 101. A fluid contacting surface of the forward scoop 105 can define any suitable shape such that the shape enhances the reduction of static pressure and increases local dynamic pressure to reduce the differential pressure between forward and aft sides of the stator 100. Referring to FIG. 2, flow discourager 507 can be flat on top and/or flush with the stator platform 503. A rotor platform 511 from the following rotor blade 301 can also be contoured and extend underneath the flow discourager 507 creating an axial overlap thereby creating a tortuous flow path of any suitable design.

Referring again to FIG. 1, the flow discourager 107 can be configured to guide flow 99 that is exiting stator 100 to flow into the next rotor 301 by directing the flow path and/or creating a laminar flow barrier. Also, as shown in FIG. 1, the flow discourager 107 can also be configured to cause turbulence via flow separation to prevent fluid flow from traveling toward gap 50 and back to the lower pressure forward side of stator 100.

One or more flow guides can extend from a surface of the stator platform 103 opposite the stator airfoil 101. For example, in FIG. 1, stator platform 103 includes a first flow guide 109A and a second flow guide 109B extending from the surface of the stator platform 103 opposite the airfoil. The flow guides can be obliquely offset from the stator platform 103 relative to the radial and axial axes. For example, the first flow guide 109A and the second flow guide 109B each extend obliquely with respect to the stator platform 103. While two flow guides 109A, 109B are shown, any suitable number of flow guides may be used, including one and zero.

The flow guides 109A, 109B act as flow discouragers to prevent backflow from the aft, high pressure side of stator 100. The flow guides 109A, 109B also reduce the size of gap 50 which enhances the sealing ability of stator platform 103 with rotor assembly 300. In some embodiments, the rotor assembly 300 can include an abrasive surface 303 that abrades flow guides 109A, 109B to minimize the size of gap 50.

As shown in FIG. 1, a portion flow 95 of the main fluid flow 99 may be directed toward gap 50 where some of the velocity of the portion flow 95 is removed by scoop 105 and converted to static pressure, i.e., by the ram effect. This increases the local static pressure on the forward side of the stator 100 in the proximity of the gap 50. The increased pressure reduces the differential pressure between the aft/downstream side of the stator 100 and the forward/upstream side of the stator 100, thereby reducing leakage and creating a partial or total seal for the seal path between stator platform 103 and rotor assembly 300.

The stator platform 103 can lead to leakage flow reductions by as much as 50% as compared to traditional seals. The stator platform 103 also reduces the rotating surface area (by removing knives and other protrusions as used in conventional seals) as well as some static surface area (by reducing the need for honeycomb and honeycomb carriers), which results in a reduction in drag and work done on the air. This can lead to heat generation reductions by as much as 50% as compared to conventional seals. Weight of the entire assembly is also reduced due to smaller components with less parts being used.

FIGS. 2, 3, 4, and 5 show different embodiments of a stator in accordance with the present disclosure. Stator 500 of FIG. 2 includes a stator airfoil 501 and a stator platform 503 with a forward scoop 505 similar to forward scoop 105 as described above but with a different cross-sectional/airfoil shape. Also, stator platform 503 does not have any flow guides 109A, 109B. Stator 600 of FIG. 3 includes a stator airfoil 601 and a stator platform 603 with a forward scoop 605 similar to forward scoop 105 as described above. However, stator platform 603 does not have any flow guides 109A, 109B and further includes a labyrinth seal, or other suitable surface contour engaging rotor assembly 700.

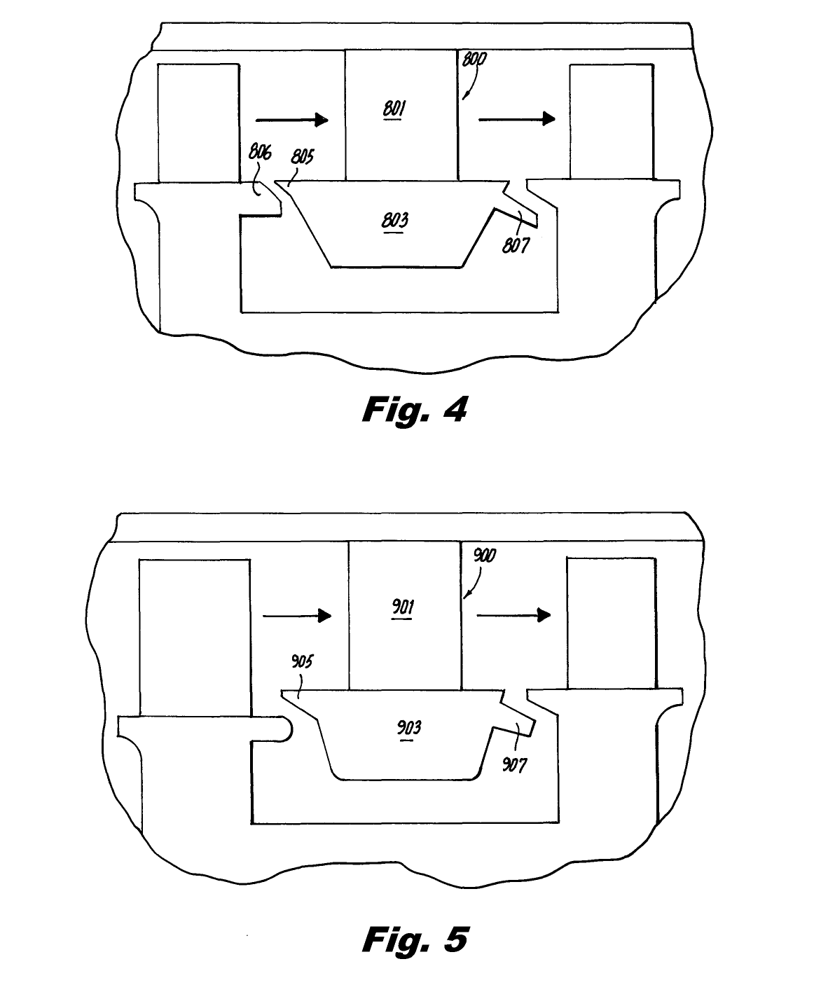

Stator 800 of FIG. 4 includes a stator airfoil 801 and a stator platform 803 with a forward scoop 805 similar to forward scoop 105 as described above but with a top surface that is flush with a top surface of a rotor blade lip 806. Rotor blade lip 806 is shown as including a rolling profile to for directing fluid flow under scoop 805, but can include any suitable design. This allows for a minimal radial protrusion (e.g. 0% of stator span) of scoop 805 into the flow path 99. Flow discourager 807 is shown extending obliquely relative to the platform 803.

Stator 900 of FIG. 5 includes a stator airfoil 901 and a stator platform 903 with a forward scoop 905 similar to forward scoop 805 as described with respect to FIG. 4 above, however, stator platform 803 radially protrudes into flow path 99 to a greater degree (e.g. greater than 0% of stator span). In this embodiment, flow discourager 907 is shown extending obliquely relative to the platform 803 and is of a slightly different shape than flow discourager 807.

In at least one aspect of this disclosure, a turbomachine casing 200 can include a stator as disclosed above. The turbomachine casing 200 can be configured as a casing for any suitable turbomachine.

In another aspect of this disclosure, a method includes the step of compressing a compressible fluid using a first rotor 301 disposed on a rotor assembly 300 and a first stator 100 disposed on a turbomachine casing 200. The compressible fluid can be compressed from a first pressure forward of the first stator 100 to a second pressure aft of the first stator 100. This compression creates a differential pressure between a forward side and an aft side of the stator 100.

The method also includes the step of directing a directed portion flow 95 of the compressible fluid on the forward side of the first stator 100 toward a gap 50 between the rotor assembly 300 and the first stator 100, and increasing static pressure on the forward side of the stator 100 proximate the gap 50 using the directed portion flow 95 of the compressible fluid, thereby reducing the differential pressure between the forward side and the aft side of the stator 100. This acts to at least partially seal compressed fluid from flowing through the gap 50 from the aft side of the stator 100 to the forward side of the stator 100.

The methods and systems of the present disclosure, as described above and shown in the drawings, provide for a stator with superior properties including a more efficient seal. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A seal component for a turbomachine, comprising:
a stator platform configured to be disposed on an end of a stator airfoil; and
a scoop disposed on a first edge of the stator platform configured to be oriented obliquely with respect the stator airfoil and configured for generating a region of high pressure static fluid flow adjacent the first edge of the stator platform.

2. The seal component as recited in claim 1, wherein an end of the scoop is axially or radially offset from the stator airfoil such that the scoop may extend axially or radially inward or outward.

3. The seal component as recited in claim 1, wherein a surface of the scoop defines an airfoil.

4. The seal component as recited in claim 1, wherein the scoop is a forward scoop and the stator further includes an flow discourager defined on a second edge of the stator platform opposite the forward scoop.

5. The seal component as recited in claim 4, wherein an end of the forward scoop or flow discourager is axially or radially offset from the stator airfoil.

6. The seal component as recited in claim 4, wherein a surface of the forward scoop defines an airfoil.

7. The seal component as recited in claim 1, further including a flow guide extending from a surface of the stator platform opposite the airfoil.

8. The seal component as recited in claim 7, wherein the flow guide extends obliquely relative to the stator platform.

9. The seal component as recited in claim 7, wherein the flow guide is a first flow guide and the stator platform further includes a second flow guide extending from the surface of the stator platform opposite the stator airfoil.

10. The seal component as recited in claim 1, wherein one or both of the stator platform and the scoop are annular.

11. A turbomachine, comprising:
a plurality of stators each including:
a stator airfoil; and
a stator platform operatively connected to an end of each stator airfoil with a scoop disposed on a first edge of the stator platform oriented obliquely with respect the stator airfoils and configured for generating a region of high pressure static fluid flow adjacent the first edge of the stator platform.

12. The turbomachine as recited in claim 11, wherein an end of the scoop is axially or radially offset from the stator airfoils such that the scoop may extend axially or radially inward or outward.

13. The turbomachine as recited in claim 11, further including a rotor having a rotor blade and a rotor lip, wherein the rotor lip includes a curved surface, wherein a top surface of the scoop is flush with a top surface of the rotor lip.

14. The turbomachine as recited in claim 11, wherein the scoop is a forward scoop and the stator platform further includes an flow discourager defined on a second edge of the stator platform opposite the forward scoop.

15. The turbomachine as recited in claim 14, wherein an end of the forward scoop or flow discourager is axially or radially offset from the stator airfoils.

16. The turbomachine as recited in claim 14, wherein a surface of the forward scoop defines an airfoil.

17. The turbomachine as recited in claim 11, further including a flow guide extending from a surface of the stator platform opposite the airfoils.

18. The turbomachine as recited in claim 17, wherein the flow guide extends obliquely relative to the stator platform.

19. The turbomachine as recited in claim 17, wherein one or both of the stator platform and the scoop are annular.

20. A method, comprising:
compressing a compressible fluid using a first rotor disposed on a rotor assembly and a first stator disposed on a turbomachine casing, the compressible fluid being compressed from a first pressure before the first stator to a second pressure after the first stator, thereby creating a differential pressure between a forward side and an aft side of the stator;
directing a directed portion flow of the compressible fluid on the forward side of the first stator toward a gap between the rotor assembly and the first stator; and
increasing static pressure on the forward side of the stator proximate the gap using the directed portion flow of the compressible fluid, thereby reducing the differential pressure between the forward side and the aft side of the stator, which acts to at least partially seal compressed fluid from flowing through the gap from the aft side of the stator to the forward side of the stator.
